(19) United States
(12) Patent Application Publication
(10) Pub. No.: US 2013/0149081 A1
(43) Pub. Date: Jun. 13, 2013

(54) METHOD AND APPARATUS FOR EFFICIENTLY FILLING AND UNLOADING FLAT AND HOPPER BOTTOM GRAIN BINS FROM THE BOTTOM USING ONE CONVEYOR

(71) Applicant: Ronald T. Noyes, Stillwater, OK (US)

(72) Inventor: Ronald T. Noyes, Stillwater, OK (US)

(21) Appl. No.: 13/710,240

(22) Filed: Dec. 10, 2012

Related U.S. Application Data
(60) Provisional application No. 61/569,196, filed on Dec. 9, 2011.

(51) Int. Cl. B65G 65/30

(52) U.S. Cl. CPC B65G 65/30
USPC 414/298; 414/808

(57) ABSTRACT

The embodiments described comprise a method of filling a flat bottom or hopper bottom grain bin with grain, seeds, or other granular or particulate materials by pushing the granular material through a nominally horizontal or inclined cylindrical tube or u-trough into the bottom center floor opening, where a smooth pipe elbow or inclined plane causes the granular material to turn and flow upward where it cascades into a pile on the floor or into the coned bin hopper bottom, with the pile continuing to rise to a desired level, then reversing the embodiment direction of operation, removing all freely flowing material from the bin through the same tube, using this embodiment to fill and unload several bins, minimizing conveyors to fill and unload every bin. A vertical slotted fill pipe can provide a method to reduce friction while filling tall bins by reducing friction of forcing grain through grain.

### CROSS-REFERENCE TO RELATED APPLICATIONS

This application claims priority of the U.S. Provisional Patent Application with Ser. No. 61/569,196 titled “Method and Apparatus for Efficiently Filling and Unloading Flat and Hopper Bottom Grain Bins from the Bottom Using One Conveyor” filed on Dec. 9, 2011. The entire contents of U.S. Provisional Patent Application 61/569,196 is incorporated by reference herein.

### STATEMENT REGARDING FEDERALLY SPONSORED RESEARCH OR DEVELOPMENT

Not applicable

### FIELD OF THE EMBODIMENTS

The field of the embodiments is the loading and unloading of granular materials.

### BACKGROUND OF THE EMBODIMENTS

For the past century, the primary method for filling large grain storage units, whether flat storage building, concrete silos or corrugated or welded steel bins has been the use of one or more vertical ‘bucket’ (belt and cup) elevators which carry grain vertically upward in metal or plastic scoop-like “cups” on a continuous rubberized fabric composition belt inside an enclosed metal bucket elevator leg housing. As the belt passes over the top head pulley, the grain discharges by either falling out of the cup (gravity) or with sufficient belt speed and head pulley diameter, it is discharged forcefully by centrifugal force into piping, valves, and other conveyance devices which guides the grain or granular material downward by through tubular gravity spouts directly into storage bins, or into other conveyors which discharge into storage bins.

These “bucket” (belt and cup) elevators are typically 70 to 100 ft tall as a minimum, and in some cases as much as 250 to 350 ft high at the head section discharge opening. Grain accelerates rapidly as it slides down the sloped spouts, which must be at least a 40 degree angle from horizontal, but are often much steeper—60-80 degrees from horizontal. In many of the elevators, grain quickly reaches terminal velocity coming down steep grain spouts, discharges from the spout at the top of the bin, drops the full height of the bin and violently impacts the concrete floor or other grain as the bulk pile forms, causing considerable quality damage through grain or seed breakage. Even grain hitting grain that is already on the floor of the bin or the grain pile surface with the tank almost full is damaged.

Grain pushed up through the base of the storage travels much slower. The maximum forces are just the compression of grain against grain as the conveyor forces it upward through the surrounding grain in the weak center shear zone of the bulk as it flows up to the peak.

Besides providing gentler handling of grain, bottom filling and unloading will greatly reduce the investment cost for grain handling in new grain facilities and expansion of older grain systems, and will reduce the roof design loading structural costs of the bins. Grain bin roof and sidewall designs only need to handle their existing dead load plus a suitable snow and wind load. Eliminated is a 25,000 to 35,000 lb structural roof load for conveying equipment that the roof designs normally have to meet. Overall facility grain transfer investment and physical equipment investment will be greatly reduced. Worker safety will be greatly enhanced by eliminating most of the climbing—elevator insurance rates will be lower.

### SUMMARY OF THE EMBODIMENTS

The embodiments described herein relate to filling and unloading grain bins with one common screw auger conveyor. They further relate to using as few as one auger conveyor power unit to service a relatively infinite number of grain (or other granular products) storage structures, using one base auger tube diameter, one auger power drive unit can service a wide range of grain storage units, of various diameters, widths and heights by adjusting as needed the length of the flighting that slides into the base auger tubing to match the length of that tube. More particularly, the embodiments relate to bolted steel flat bottom or hopper bottom steel bins. With one hopper bottom bin, the entire bin can be filled and unloaded using the same auger conveyor by reversing the rotation of the auger flight rotation, and by fitting the power unit with a filling hopper on the top side of the short power section auger tube, and a discharge opening installed on the bottom side of the power unit auger (FIGS. 1-4). The discharge opening chute is fitted with a slide gate which can be closed when the power unit is used for filling the grain bin.

With multiple hopper bottom bins (FIGS. 5 and 6), several bins may be aligned so that one auger system can be used to fill several bins in one direction, and unload any of those bins using the same rotation of the flighting with the discharge on the opposite end, thereby using a simpler power and control system with the auger rotation constant (no motor reversing). However, if preferred, filling and unloading can be done on the same end by reversing the direction of motor and auger flighting rotation, wherein the fill hopper and discharge openings are on the same end of the unit, as used for flat bottom bins. With hopper bins, a special designed discharge box can be installed to replace the standard discharge box at the base of the bin hopper being filled.

All other bins in the line are equipped with removable bottom half-round sections which provide flow through of grain to the bin to be filled or to the auger discharge. In the hopper installed on the bin to be filled, and a slotted inclined grain turning plate slides up straddling the auger drive shaft; the gap in the sloped turning plate and is filled by a narrow inclined plate section, keeping grain from leaking past the turning plate as it flows upward into the selected hopper bin.

A major advantage of filling individual hopper bottom bins is the very short distance required of the power unit from fill hopper to base of hopper bin. Thus, when low friction plastic material is used to coat the fill/discharge elbow, auger flighting and auger pipe tube liner, most of the power required is for pushing the grain upward to fill the storage structure.

With flat bottom grain bins, one or more horizontal tubes may be placed in the floor to fill or to unload the structure. This may be preferable when two or more rows of bins are positioned in parallel where it is desirable to transfer from one bin in a row to another bin in the opposite row, using an inclined transfer conveyor between two horizontal power unit conveyors.

Wolstenholme (U.S. Pat. No. 4,493,248) teaches the use of a horizontal auger to form piles of grain and to push grain into the base of a flat bottom bin. However, Wolstenholme does not teach filling and unloading of the same bin using the same auger, nor does he teach of filling and unloading one or a multiplicity of hopper bins using one composite fill and unload power unit and its connected auger flighting by reversing the motor and auger flighting rotation. Furthermore, Wolstenholme makes no mention of filling and unloading one or a multiplicity of hopper bins using one auger. Nor does Wolstenholme introduce the use of low coefficient of friction plastic coatings on auger flighting, or auger tubing, or tubing elbows to greatly reduce the resistance to flow and thus the horsepower required to transfer the grain from start to finish during filling of grain bins.

To further enhance filling and unloading flat bottom bins, it is very beneficial to use a smooth-walled pipe elbow to cause the grain to turn upward more easily. Even smoother and lower energy to achieve this 90 degree turning of the grain (or other granular or particulate material) can be achieved by lining the 90 degree elbow with a low coefficient of friction material such as, but not limited to, ultra high molecular weight polyethylene (UHMW) plastic material, nylon, or other slick plastic materials, which have a much lower coefficient of friction than various types of steel materials. The low friction plastic will reduce the power required as well as the wear and damage of the granular materials during turning in the elbows.

Further power savings can be achieved by lining the “push” or pressure face of the fill conveyor auger flighting (on the side used for pushing the grain into the storage) with low friction plastic, thus greatly reducing the frictional resistance and the power and time required to fill the structures. Savings in power can be used to increase the handling rate of the conveyor. Further reduction in resistance to flow of the grain through the conveyor can be achieved by lining the auger tube in the base of the structure with a low friction plastic tube liner. Reducing the friction of handling and the power required to push the grain into the structure will also reduce wear damage to grain being pushed into the bin and upward through the grain bulk. Cost of low friction plastic liners are offset by lower electric motor and power operating costs.

As grain is pushed through the tube, and turns upward and begins to flow through a vertical core shearing zone, there is resistance to upward flow by the pressure exerted by the static grain pressures in a bulk pile near the center of the mass. A method to minimize the frictional drag of grain being pushed upward through grain, to form a low pressure vertical core of grain will be to place a vertical tube directly above the outlet of the discharge hopper, which includes a 90 degree elbow. This vertical stand pipe has a gap of several inches underneath to allow grain to flow directly into the unload auger well during unloading of the bin. This vertical pipe (FIG. 3) may include a flared or enlarged inlet and is preferably larger by 1.5-2.0 times the ID of the elbow outlet diameter so grain upward velocity is slower.

The stand pipe includes periodic openings in the sidewall whereby grain can discharge from the vertical pipe and form the pile and surface slope. When the grain bulk slope reaches and covers the opening, grain will then flow past grain that plugs the opening until another set of openings is reached higher along the pipe. This process will repeat until the bin is filled or there is no more grain to transfer. To further enhance vertical filling, the vertical pipe can be lined with low friction plastic tubing, thus greatly reducing the energy required to push the grain vertically to fill the bin.

In some large, tall flat bottom structures, it may be desirable to install a vertical tube or pipe over the floor inlet elbow to provide a controlled reduced friction (lower than grain-against-grain resistance) channel for grain to be pushed upward through. This vertical stand pipe will contain periodic openings in the sides of the pipe through which grain can flow outward until the grain pile reached and covered the top of that opening, then the grain will continue flowing upward to the next opening and spill out until the grain surface slope covered that hole.

With this pipe lined with low friction plastic, the ease of filling the bin, compared to pushing grain through grain will be substantially reduced, thereby allowing faster filling with lower motor power. Slots on the sides of the stand pipe as well as a gap at the bottom of the vertical fill pipe will allow grain to flow into the openings and down through the pipe to the auger discharge opening during unloading of the bin, with final outflow through clear space under the base of the pipe, until all the free flowing grain flows out to the unload auger. Pushing the grain out of the base tube using the standard steel auger flight facing will require much less power than during the filling operation. Thus, the plastic flight facing is not needed as much during bin unloading operations. However, when desired, the auger flighting can be removed from the under-floor tube and reversed so the plastic faced flighting is used for unloading as well as loading.

Since the low friction plastic flight facing material covers the outer edges of the auger flight, and has a very low coefficient of friction on steel, the plastic flighting material will provide bearing support along the bottom of the auger tube, so U-trough augers without hanger bearings can be used from the edge of the bin to near the center. However, the final few feet of grain travel must be inside a smooth walled pipe in order to connect directly to the pipe elbow and provide smooth controlled pressure forcing the grain into the elbow. Otherwise grain would spill over the top of the flighting in the U-trough, creating congestion and grain shear damage as the grain is forced into the elbow. If smooth wall tubing is more economical, then tubing will be suitable for the entire tube from outside the bin base to the center fill and discharge well.

These embodiments therefore contemplate filling a grain storage structure from bottom to top, then removing the grain from top to bottom using the same equipment to unload as used for loading by reversing the direction of rotation. Also, it is known by the inventor that one power unit with auger flighting of suitable length to reach the center of the storage, can be moved from bin to bin, then inserted into the built-in load/unload tube at the base of the structure, with each storage unit containing only the permanent under-floor or on-floor tube (or a multiple under-floor tubes in some bins if desired to fill and unload from multiple directions, or where two fill conveyors may be used for blending grain) and using at least one portable power unit for filling and unloading, thus greatly minimizing the investment in transfer equipment, and minimizing the height of the grain facility to the highest bin roof, while minimizing the cost of the bin roofs by not having to support heavy overhead equipment.

However, if it is deemed to be desirable, the auger flight shaft can be reversed and connected to the power unit so the plastic faced auger flighting can also be used to push the grain out of the bin during unloading operations, providing low friction resistance and thus low power while maintaining continuous high conveyor capacity during the unloading operation.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1—a schematic side view showing bottom filling of a flat bottom bin using a moveable fill and unload screw conveyor for multiple bins

FIG. 2—a schematic side view showing unloading of a flat bottom bin using a moveable fill and unload screw conveyor with inclined removable power section.

FIG. 3—a schematic side view showing loading and unloading of a flat bottom bin using a moveable screw conveyor to fill the bin through a vertical stand pipe with side wall openings to minimize grain flow resistance and increase fill rate with reduced power.

FIG. 4—a perspective schematic grain facility layout for flat bottom grain bins with bottom fill and unload showing grain transfer options between bins using one or more moveable bottom fill conveyors.

FIG. 5—a schematic side view showing bottom filling and unloading of hopper bottom bins using a common fill and unload screw conveyor—one bin can fill while a second bin unloads using one conveyor.

FIG. 6—a perspective schematic grain facility layout for hopper bottom grain bins with bottom fill and unload capability showing grain transfer options using one moveable bottom fill/unload conveyor to service several rows of bins.

### DETAILED DESCRIPTION OF THE PREFERRED EMBODIMENTS

The embodiments comprise a method and devices to transfer a grain bulk lot or volume from a supply source into one or a multiplicity of grain storage container units which may be flat bottom bins, hopper bins, flat storage warehouses, concrete silos, or grain bunkers by filling and unloading these storage units by a nominally horizontal conveyor at the base of each storage—filling from bottom to top—using only one conveyor power unit and auger flighting (but not limited to one conveyor and power unit) for all filling and unloading operations.

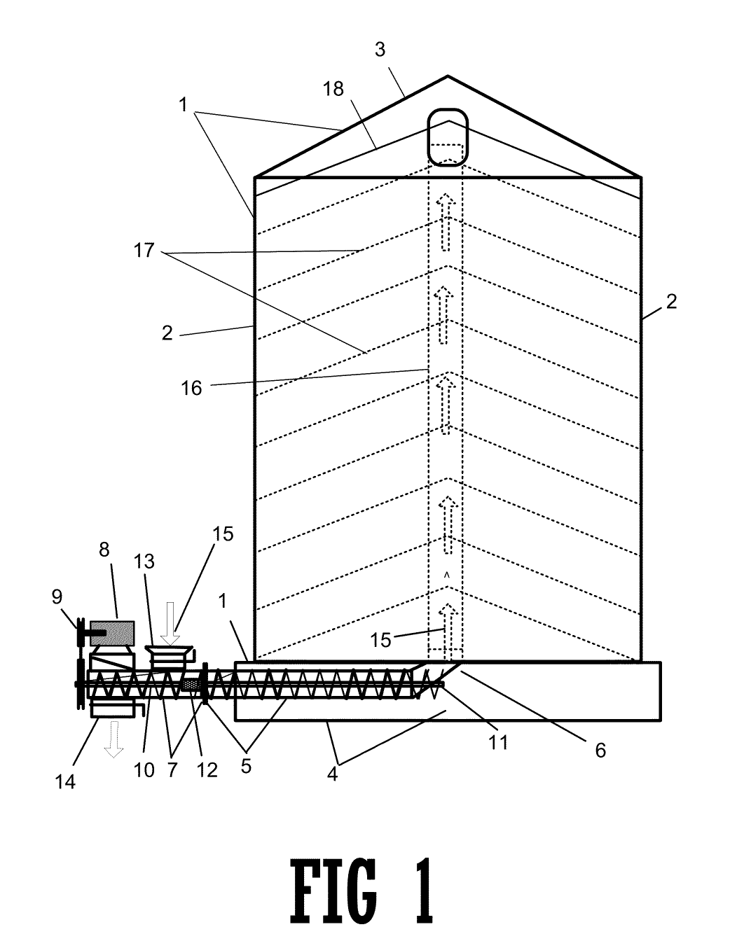

In one embodiment, grain storage structure (1), as shown in FIG. 1, comprises a flat bottom grain bin comprising a cylindrical container (2) with a roof (3) which has a structural base (4) which contains a base conveyor tube (the tube may lay on top of the base floor) with flanged outer opening (5) with conveyor tube further enhanced by connection to an elbow (6) which smoothly turns the grain upward with minimum flow resistance.

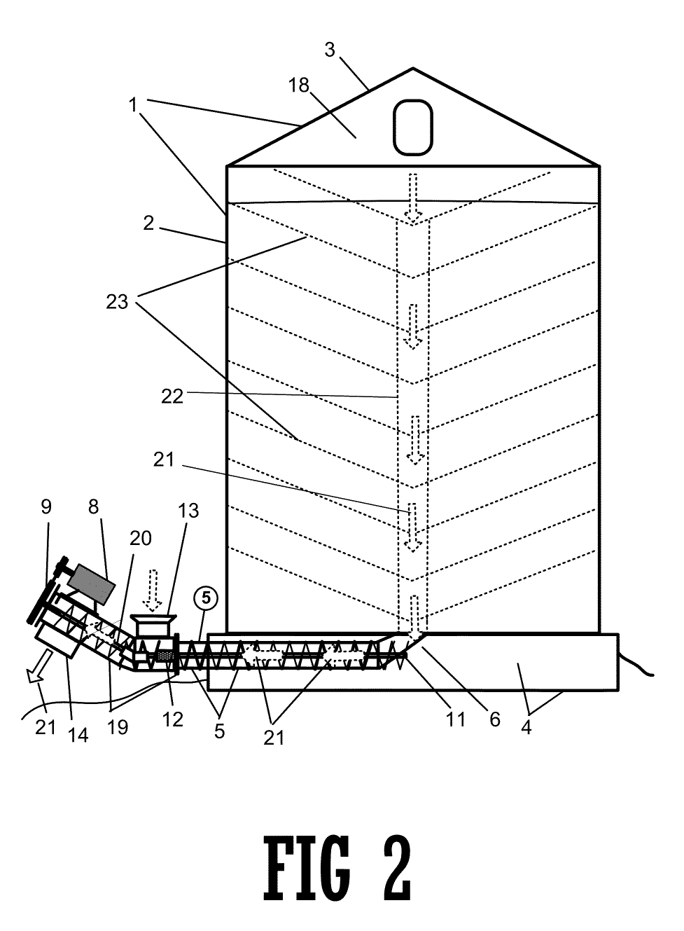

Filling and unloading of the storage unit (1) is preferably accomplished by a uniquely designed horizontal screw conveyor with power unit (7) comprising a drive motor (8), a power speed reduction assembly (9) and short auger flighting (10) to which is further attached an auger flighting assembly extension (11) which connects to the power train by coupling assembly (12), the auger power unit contains an inlet fill hopper (13) and a discharge outlet (14) for filling and unloading operations. Depending on ground clearance of the base, the screw conveyor also comprises an articulated inclined fill and discharge power unit (19) shown in FIG. 2.

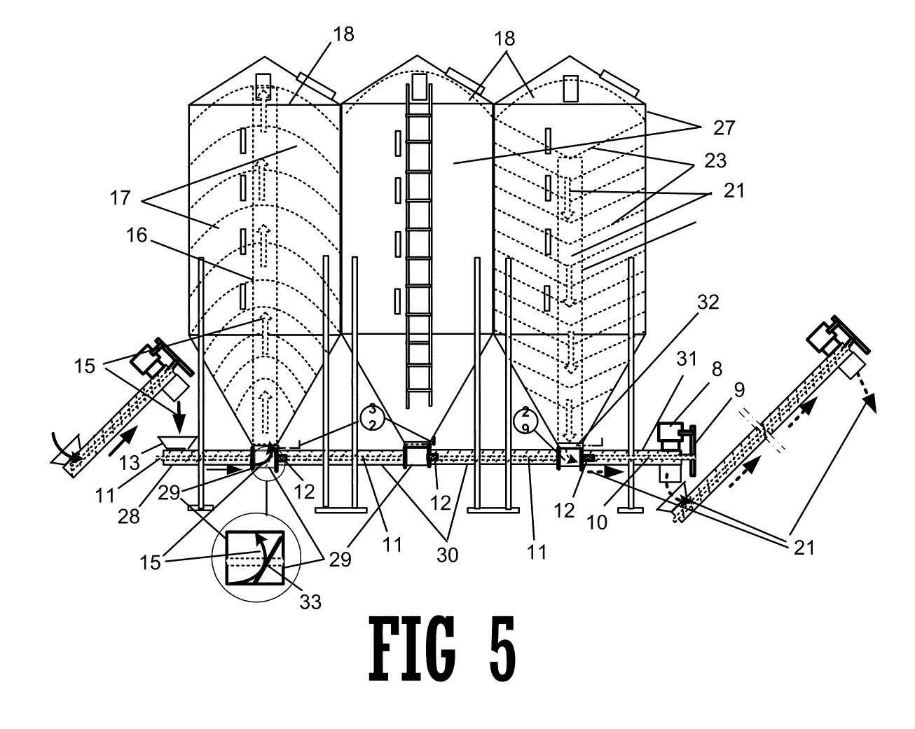

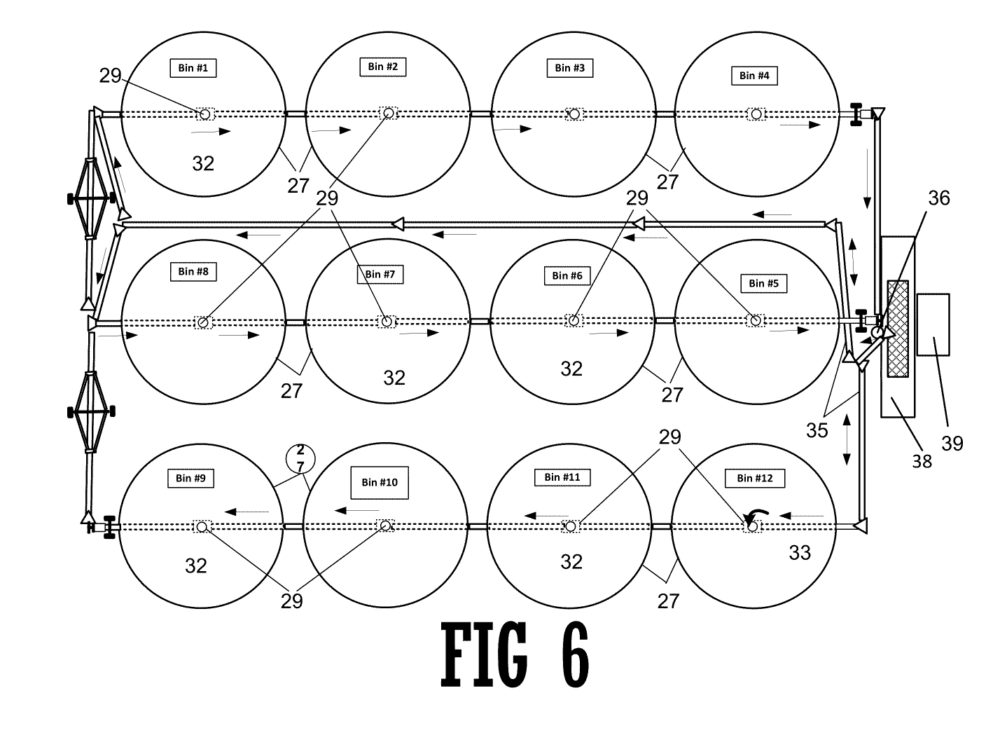

Bin 1, shown as a flat bottom storage unit (FIGS. 1, 2, 3, 4) but which can also be a hopper bottom bin (FIGS. 5-6) and other types of storage with walls, base and top covering, is preferably filled and unloaded by, but is not limited to, a unique design of screw conveyor.

Dense phase pneumatic conveyors can also be used for filling from the bottom of the storage through installed base tubes of appropriate diameter to match the conveyors air flow and desired grain delivery capacity. Dense phase or dilute phase pneumatic conveyors may also be used for bottom unloading the bins through the same type of horizontal base tube used for screw conveyors.

Embodiments of the grain storage bin (1) can be filled using a horizontal screw conveyor powered by a drive system causing it to rotate in the proper direction for pushing granular materials and products, such as grain, seeds, pellets, and other granular particulate matter, either biological products or manufactured products, which enter the conveying device through inlet hopper or receiver (13), the material, grain, (15) moves through auger tube (5) pushed by auger screw (11) connected by coupling (12) to power unit auger (10) which is powered by motor (8) through drive speed reducer (9), then turns the grain from horizontal to vertical flow through elbow (6), where the grain (15) begins to flow upward in a core of moving grain (16) through static grain resulting in a continuous rising pile surface (17), propelled by the pressure from following grain materials until it reaches the desired surface level (18).

The continual push of grain through the horizontal base conveyor tube and elbow forces the grain to flow upward through a loose center core (16), with grain spilling out and slowly trickles down the continually rising grain bulk slope surface (17) with the action similar to the hot core during volcano eruption, where the grain flows down the face of the pile at the natural angle of repose (17) for the specific grain material.

The coned grain pile surface (17) flows continually downward to the floor, with the peak of the coned pile slowly rising, gradually spreading in diameter until the grain reaches sidewall (2) of storage bin (1) where the slowly flowing grain slope (17) is restrained from further outward flow by bin sidewall (2). As the depth of the grain bulk increases, the pressure against the horizontal force through the conveyor tube that is exerted at the top of elbow (6) gradually increases, so the driving force power increases to maintain the flow rate but part way through the filling process, the flow rate gradually slows as the motor energy (electrical amperage) increases until bin (1) is filled to the desired height (18).

When storage of grain and other granular products has been maintained for a desired time, it is necessary to unload the storage structure so the products can be transported to market or delivered to buyers of the product. These embodiments comprise a means whereby the unloading of the structure is conducted in a simple, efficient, low cost manner by using the same conveyor power unit that is used to fill the structure by reversing the rotation of auger flighting (11 and 10) in auger tube (5) to unload the structure as illustrated in FIG. 2, thereby saving the considerable cost for additional dedicated unloading equipment used in conventional grain and granular product storage systems.

In this novel grain conveying system the same conveyor unit can be used to unload the flat bottom storage bin (1) by simply reversing the direction of rotation of the auger conveyor screw. When three phase electric motors (8) are used for power, reversing the auger rotation is simply done by switching the power of any two of the three power supply conductors.

When desirable, to use the same polished face of the auger flighting to minimize electrical energy required for unloading, the screw conveyor shaft (11) can be disconnected at coupling (12) from short power unit auger section (10), then is turned around, reconnected and inserted back into auger tube (5), so it can push the grain (21) flowing by gravity through elbow (6) as a downward flowing core of grain (22), causing a reverse sloped cone (23) to form; the grain (21) is pushed to power unit discharge outlet (14) where it flows into the inlet of a transfer conveyor.

When the three motor lead power wires are numbered, L1, L2, L3, by exchanging the positions of L1 and L3, or L1 and L2, or L2 and L3, motor rotation is reversed and the motor can operate the auger conveyor at full power in the opposite direction of rotation. By reversing the rotation of a standard auger flighting, grain products can be easily withdrawn through the elbow that makes up the “discharge receiving well” into the horizontal tube at the center of the structure and the grain is conveyed out of the bin through the same horizontal tube used to fill the bin.

If an on-floor tube is used instead of a tube inside the base of the bin, when the conveyor auger rotation is reversed, the exposed flighting of the auger conveyor will pull grain into the auger tube, conveying it out of the bin, until all grain that will flow by gravity to the exposed auger flighting has been discharged from the bin.

This action of the exposed auger flighting, whether the auger tube is under the floor or is placed on the floor, immediately causes a loosened core of grain (22) to flow downward through the entire grain bulk from top center to bottom, causing an inverted cone surface (23) to form where the natural dynamic angle of repose of the grain slopes to the center.

The innovation in this unique and novel process is to immediately form at grain surface (23) and progressively flow at the natural angle of repose of the grain down the face of cone (23) until all of the grain that will flow by gravity has flowed through elbow (6). In FIG. 2, an alternative inclined auger discharge unit (19) is illustrated for use where there is insufficient space under the horizontal power unit (7) but the function of both the inclined and horizontal power units are the same.

In this novel concept, the same power unit (7 or 19) and the full length auger flighting (11), can be removed from one bin and moved to any number of bins by simply disconnecting the tube flange connections (7 and 19) near the bin base, and disconnecting coupling (13) allowing power unit to be moved aside and flighting (11) is removed from base auger tube (5) so the power unit assembly (7 and 19) and auger flighting (11) can be easily moved to other bins, or can be moved to other grain storage sites.

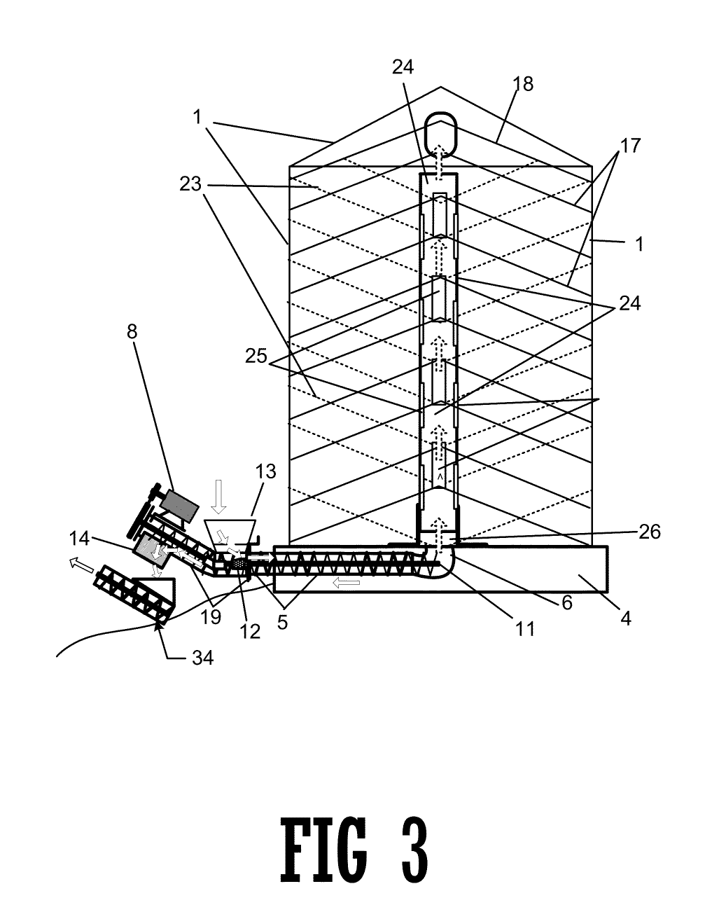

In tall grain bins, the power required by the horizontal auger to push the grain upward through very deep grain, or when conveying small grains where frictional resistance is higher, upward grain flow resistance can be considerably reduced, power reduced and conveyor capacity enhanced by the addition of a smooth wall vertical tube (24), as shown in FIG. 3, where the tubing contains openings (25) to allow periodic outflow of grain at moderately spaced vertical increments, where the openings may be at the same elevation, or as shown in FIG. 3, may alternate such that a more or less continuous outflow of grain 17 occurs.

To further reduce frictional flow resistance, the vertical grain discharge pipe may also be of a larger diameter by 1.5 to 2.0 times the diameter of the outlet of elbow (6) or more, thus slowing the velocity of grain being pushed upward. Further power reduction can be provided during the vertical passage of grain through tube (24) by lining the tube with low frictional resistance plastic such as that used in horizontal base auger tube (5) and elbow (6) to minimize auger motor load, and allow for continual high capacity conveying throughout the depth of the storage bin (1).

During unloading of bins containing vertical slotted grain discharge tube, grain will gravity flow into the top of the tube (24), then into the various sidewall openings (25) providing a controlled downward flow of grain into elbow (6) where exposed auger flighting 11 will propel the grain through auger tube (5) to power unit discharge (14). The base of the vertical slotted pipe is supported a desired distance (26) above the bin floor over the center elbow (6) by narrow support brackets allowing grain to gravity flow down the inverted grain cone surface (23) below the pipe into the elbow, allowing all grain to flow out of the bin that can gravity flow.

This power unit and extended auger flighting can conveniently be mounted on a chassis with wheels for ease in moving and inserting in various bins at the primary storage site, or by other transport moved to other secondary storage sites, thus saving a great amount of investment in conventional bucket elevators, distributors, down spouts, bracing equipment, support towers, safety ladders, catwalks, etc—normally purchased and erected at conventional grain elevators, large farms, grain terminals and ports.

Such conventional high elevation conveying and support equipment not only comprises high safety risks for workers during construction but also during use, and requires considerable periodic or continuous maintenance. The installation and maintenance cost of conventional elevation and overhead conveying equipment often reaches 30-40% of the cost of the storage structures which it services, and in some cases may reach 50% of storage structure costs.

These embodiments propose to greatly minimize the initial construction cost, safety hazards, insurance, and operating costs of filling and unloading conventional grain storage bins. Another important feature of these embodiments is that it can be easily adapted to fill and unload a wide variety of bin diameters using only one power unit and several auger sections (11) of desired lengths, an extremely low cost option.

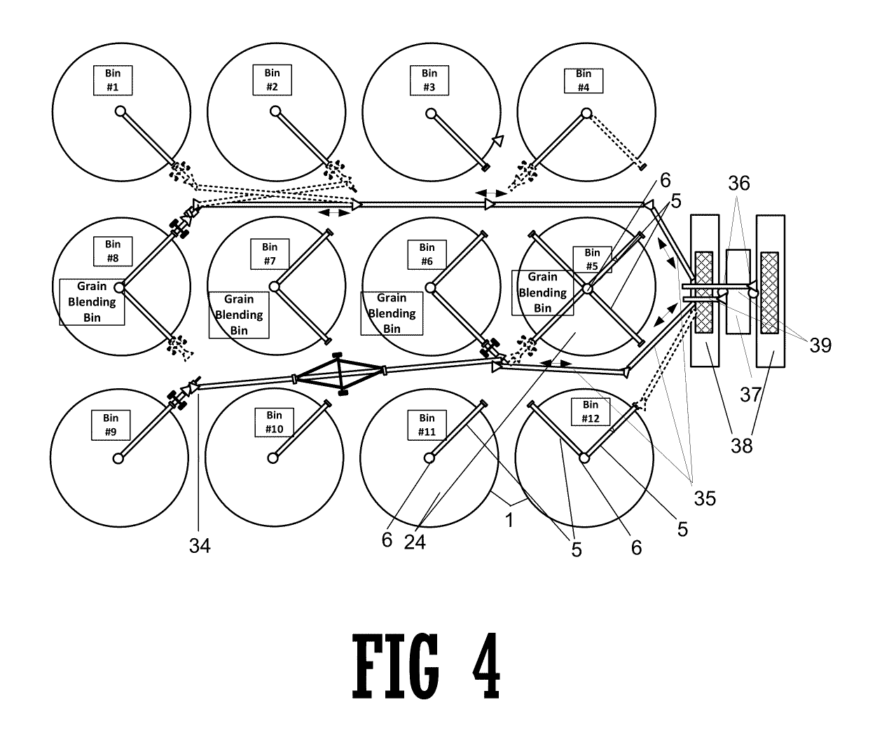

FIG. 4 illustrates a typical layout of grain bins with alternative under bin floor or on-floor auger tubes and possible optional grain transfer methods. Horizontal conveyors of various types as shown can be used as moveable or permanent efficient grain transfer operations. This layout shows two truck dump sheds (38) (or one truck shed and one rail shed) with a dump through scale on both sides of the scale house and office (37). The facility can use short vertical or inclined conveyors (36) to transfer grain through short overhead conveyors (39) from the dump pit(s) to horizontal ground level transfer conveyors (35) for bin filling. Reversible conveyors (35) allow the same conveyors to return grain to the truck (or rail) shed for load out as needed.

In addition to filling and unloading conventional steel flat bottom bins and concrete silos, these embodiments can also be easily adapted to fill and unload hopper bottom bins (27), which are found to be more desirable for storage in certain regions of a country, or in certain countries. Not only can an individual hopper bottom bin be easily filled and completely unloaded by this technology using a moveable power unit with short auger and tube sections, a series of hopper bottom steel bins (FIGS. 5 and 6) which are constructed in-line can be serviced by one uniquely designed conveyor power unit, where the fixed auger tube sections (28, 30, 31) for the conveyor have flanges which connect to each side of hopper bin (27) discharge trough section (29), which is suspended from the bin hopper shut off valve (32). Individual auger flighting sections (11) connected by auger shaft couplings (12) can be used to make auger assembly easier, but if preferred, one long auger section (11) can be fabricated to extend from the fill end to connect to the power section auger flighting (10). In either situation, the auger shaft in each box must have no flighting where the inclined plate (33) is installed to turn the grain upward into the bottom of each hopper bin.

As shown in a preferred view in FIG. 5, the fill hopper (13) is on one end and the power unit 31 on the opposite end with auger discharge (14); however, the auger system can also be designed with inlet (13) and discharge (14) on the same end, if desired, as shown for flat bottom bins, FIGS. 1, 2 and 3). Or the conveyor can be powered from the fill hopper end with the discharge on the end opposite the fill hopper.

As shown in the preferred configuration of FIG. 5 and FIG. 6, with filling on one end and discharge on the opposite end, the rotation of the auger does not need to be reversed to fill and unload. The filling procedure is facilitated by a special inlet/outlet box (29) whereby a partial elbow or an inclined diverter plate (33) is installed to cause the grain to efficiently turn and flow upward into the bin during filling operations.

With hopper bins, flanged auger tubes (28, 30, 31) are connected between discharge boxes (29) attached to the cone bottom of each bin, so that several bins in each row and a large number of rows of bins can be economically serviced by only one auger power unit. FIG. 6 demonstrates.

An additional management feature of multiple in-line hopper bin facilities using these embodiments is that while one bin near the fill hopper is being filled, another bin farther along the row can be unloaded by the same auger, as illustrated by bins one and three, FIG. 5.

During bin unloading in the grain facility shown in FIG. 6, if the left end bin in the middle row is to be unloaded, slide gate (32) for that hopper bin is opened and grain drops through the box onto the auger trough where the flighting conveys it through three bin hopper discharge boxes (29) to the auger discharge outlet (14). This facility illustrates one truck shed with dump through scale (38) beside the office (37), but many combinations are optional with this low cost grain handling process.

Said conveyor power unit used with hopper bins in FIG. 5 may be straight in line as shown in FIG. 1, or it may be inclined for ease in discharging into an on-ground transfer conveyor hopper, FIG. 2.

Yet another desirable feature of the in-line or inclined auger power unit which can be mounted on a wheeled chassis for ease in moving from bin to bin as illustrated in FIG. 4, is that the face of the auger flighting (10, 11), can be covered with a low friction material, such as ultra high molecular weight [UHMW] plastic or nylon, which have a very low coefficient of friction compared to steel auger flighting. Such low friction material will substantially reduce the power required to convey a given mass of granular product, thus allowing higher grain flow with the same electric power. If preferred, auger tubes (5), which are installed in each flat bottom bin or hopper bin tubes (28, 30, 31) can be lined with a similar plastic tube liner material, to further reduce the power required to convey the grain. Such incorporation of low coefficient of friction materials is claimed as an important improvement compared with conventional auger conveyors.

Because grain discharging from a bin at the center flows by gravity to the center well, there is much less power required to unload a storage bin than to fill the same bin from the base. Thus, the low friction plastic material is normally installed on the ‘push’ face of the auger only, and not necessarily on the pull (back side) face of the auger flighting which pulls the grain out of the bin when the drive motor rotation is reversed. But the auger flighting (11) can be physically reversed by disconnecting drive shaft coupler (12) between the short power unit auger flighting and the main auger shaft that goes into the main bin tube, and inserting the auger flighting in the opposite direction. Thus, the plastic coated flighting is facing the direction so it will push the grain out of the bin when the motor (8) auger (10, 11) rotation is reversed.

Another important economic feature of these embodiments is that with this desired bottom filling and unloading systems, there is no need for any structure on the site to be higher than the highest grain bin roof peak. Since there is no need to support heavy conveyors, downspouts and other support structures on the roof of the bins, the roof and possibly the sidewall structure of the bin will not need to be over-designed, thus allowing a storage bin with lighter roof structure (if the roof only needs to handle snow and wind loads), thus reducing significantly the cost to manufacture, ship and assemble grain bins of each storage size.

I claim:

1. A device for moving granular materials comprising a flat bottom grain bin comprising a cylindrical container with a roof that has a structural base comprising a base conveyor tube with flanged outer opening with conveyor tube further enhanced by connection to an elbow that smoothly turns the grain upward with minimum flow resistance.

2. The device for moving granular materials described in claim 1 comprising
a. a horizontal screw auger conveyor with a power unit comprising
i. a drive motor,
ii. a power speed reduction assembly, and
iii. short auger flighting connected to the speed reduction drive shaft
iv. a longer auger flighting assembly extension that connects to the power train by a coupling assembly, wherein power unit also comprises
1. an inlet fill hopper, and
2. a discharge outlet for filling and unloading operations.

3. The device for moving granular materials described in claim 2 comprising an articulated inclined fill and discharge power unit to allow elevated discharge of product.

4. The device for moving granular materials described in claim 2 with the additional step of using one or more flat bottom bins which may have two or more discharge tubes, whereby two power unit conveyors can be used to fill the bin simultaneously with grain from two different directions to allow blending of grain quality aspects to fill the bin with a desired blend of grain.

5. The device for moving granular materials described in claim 2 with the additional step of covering the steel auger flighting by a screw flighting material comprised of ultra high molecular weight (UHMW) plastic or similar low friction material which substantially reduces the frictional resistance of grain against the screw flighting surface, allowing a given mass of grain to be conveyed into the bin with much less motor power, and minimizing the wear damage to the grain.

6. The device for moving granular materials described in claim 5 with the additional step of using the plastic coated flighting when unloading grain by disconnecting, removing and turning the extended auger flighting around so that the plastic faced screw flighting can be used during unloading of grain from the bin.

7. The device for moving granular materials described in claim 2 with the additional step that the auger tube placed under the floor or on the floor and the elbow which turns the grain upward are lined with an additional low friction plastic liner, thus reducing the friction of grain against steel, thus minimizing the power required to convey, improving the capacity of the conveyor, and minimizing wear damage to the grain.

8. A method of moving granular materials comprising the steps
a. using a horizontal screw auger conveyor powered by a drive system causing it to rotate in the proper direction for pushing granular materials and products, such as grain, seeds, pellets, and other granular particulate matter, either biological products or manufactured products that enter the conveying device through an inlet hopper or receiver,
b. the material moves through auger tube pushed by an auger screw connected by a coupling to an auger power unit powered by an electric motor through a drive speed reducer,
c. a elbow which turns the grain from horizontal to vertical flow with minimal frictional resistance, where the grain begins to flow upward in a core of moving grain through static grain resulting in a continuous rising grain cone pile surface,
d. the grain is propelled upward by the pressure from following grain materials until it reaches the desired surface level, wherein continually pushing of grain through the horizontal base conveyor tube and elbow forcing the grain to flow upward through a loose center core with grain spilling out and slowly trickling down the continually rising grain bulk slope surface where the grain flows down the face of the pile at the natural angle of repose for the specific grain material.

9. The method of moving granular materials described in claim 8 comprising the step of using the same conveyor power unit that is used to fill the structure by reversing the rotation of auger flighting in auger tube to unload the structure.

10. The method of moving granular materials described in claim 8 comprising the steps if an on-floor tube is used instead of a tube inside the base of the bin, when the conveyor auger rotation is reversed, the exposed screw flighting of the auger conveyor will pull grain into the auger tube, conveying it out of the bin wherein this action of the exposed auger flighting, whether the auger tube is placed under the floor or is placed on the floor, immediately causes a loosened core of grain to flow downward through the entire grain bulk from top center to bottom, causing an inverted cone surface to form where the natural dynamic angle of repose of the grain slopes downward to the center.

11. The method of moving granular materials described in claim 8 comprising the additional step of using a vertical pipe with a clearance space above the turning elbow such that the grain flows through the smooth walled pipe instead of having to flow through static grain, thus greatly reducing the friction of moving a core of grain through static grain, with the pipe including periodic sidewall openings to allow the discharge of grain as the cone of grain rises during filling, the vertical tube or pipe with openings raising substantially to the bin eave height and near the peak of the bin.

12. The method of moving granular materials described in claim 11 whereby the vertical pipe with periodic openings is lined with a low friction plastic material which substantially lowers the friction of the grain being pushed upward against the resistance of the steel pipe walls, thereby greatly reducing the power required to elevate the grain, allowing the conveyor to maintain higher capacity at lower power, and reducing friction damage to the grain during filling of the upper parts of the bin.

13. The method of moving granular materials described in claim 8 with the additional step of using the vertical pipe with periodic openings whereby when the power unit auger motor is reversed to operate the screw conveyor in the opposite rotation thereby removing grain from the bin, grain forms a cone and flows into the periodic openings at the upper part of the tube and down the pipe to the elbow at the floor, and into the horizontal conveyor, being discharged from the bin.

14. The method of moving granular materials described in claim 9 with the additional step of elevating the base of the vertical fill and unload pipe a sufficient distance above the floor, or above the auger flighting, providing a gap whereby when the grain bulk inverted cone reaches the lowest opening in the pipe, the grain can continue to flow under the base of the pipe into the unload auger for discharge until all the grain that will naturally flow by gravity has been discharged.

15. A method for moving granular materials, including without limitation grain, into various types of storage structures and removing said granular materials using the same conveying system comprising
a. a storage structure with a base, sidewalls to contain the granular commodity bulk and a covering system as needed for weather protection;
b. a uniquely designed and operated conveying system capable of moving the grain into storage at the base and elevating the bulk to fill the entire structure to a desired depth; and
c. the same conveying means capable of removing all of the bulk product that freely flows by gravity to a central unload receiving point of the conveying system.

16. The method of moving granular materials described in claim 15 comprising the additional step of using hopper bottom bins which allow the bins to be completely filled and completely discharged using one reversing auger conveyor.

17. The method of moving granular materials described in claim 16 with the additional step of using several bins in row alignment that can be filled and unloaded by one auger conveyor, with power unit and flighting that can be moved from one row of hopper bins to the next.

18. The method of moving granular materials described in claim 17 with the additional step of using each hopper bin with a discharge box which can allow grain to be conveyed through the box to fill bins beyond that first bin, with a special inclined plate which straddles the auger drive shaft being inserted in the box of the bin to be filled and acts like the elbow in flat bottom bins, such that the grain is turned upward to fill the bin.

19. The method of moving granular materials described in claim 18 with the additional step of using the auger conveyor that passes through the discharge box of each conveyor without reversing to discharge grain through the end of the auger opposite the power unit, or can be reversed to discharge the grain through the discharge opening of the power unit.

20. The method of moving granular materials described in claim 19 with the additional step of using a hopper bin near the inlet of the power unit which can be filled while one or more hopper bins beyond the bin to be filled can be unloaded individually or simultaneously.

21. The method of moving granular materials described in claim 20 with the additional step of using grain from two or more hopper bins in a row which can be discharged by selective amounts to allow mixing of grain of different quality aspects to provide a blend of grain to meet desired specifications such as for flour milling, or to meet contract specifications.

22. The method of moving granular materials described in claim 21 with the additional step whereby grain from two flat bottom bins can be unloaded at desired rates into a common transfer conveyor to achieve a desired specification of grain quality attributes for milling or to meet contract specifications for marketing.
